(19) United States
(12) Patent Application Publication
(10) Pub. No.: US 2025/0351792 A1
(43) Pub. Date: Nov. 20, 2025

(54) FISH WASTE TREATMENT DIGESTOR AND AQUAPONICS SYSTEM

(71) Applicant: Dachinik Domes & Aquaponics, LLC, Provo, UT (US)

(72) Inventors: Benjamin J. Jensen, Provo, UT (US); Jordan Englund, Provo, UT (US); Ken Burrows, Orem, UT (US); Sean Burrows, Herriman, UT (US)

(73) Assignee: Dachnik Domes & Aquaponics, LLC, Provo, UT (US)

(21) Appl. No.: 19/208,370

(22) Filed: May 14, 2025

Related U.S. Application Data
(60) Provisional application No. 63/648,292, filed on May 16, 2024.
(60) Provisional application No. 63/784,698, filed on Apr. 7, 2025.

(51) Int. Cl. A01G 31/02; A01G 7/04; A01G 31/06; A01K 63/04

(52) U.S. Cl. CPC A01G 31/021; A01G 31/065; A01K 63/045; A01K 63/047; A01G 7/045; A01G 31/06; A01K 63/042

(57) ABSTRACT

An aquaponics system includes a hydroponic system coupled to an aquaculture system, the aquaculture system including a fish tank, a digestor assembly, a media bed, and a fill tank. The digestor assembly includes a skimmer tank and digestor tank. Water flows from the fish tank to the skimmer tank, with solids sinking in the skimmer tank and the separated water flowing to the media bed. The solids may then be released into the digestor tank, the digestor tank including an aeration stone, air pump, and an electric pump for churning fish waste contents. Resulting soil amendments may be dispensed through a spigot. Water filters through the media bed into the fill tank and then to the grow racks. Once the water passes through the hydroponic system, the remaining water returns to the fill tank from one or more sump tanks of the hydroponic system.

### CROSS-REFERENCE TO RELATED APPLICATIONS

This application claims the benefit of U.S. Provisional App. Ser. No. 63/648,292 filed on May 16, 2024, and further claims the benefit of U.S. Provisional App. Ser. No. 63/784,698 filed on Apr. 7, 2025, both of which are incorporated herein by reference.

### TECHNICAL FIELD

The present disclosure relates to aquaponics and vertical farming. More particularly, the present disclosure relates to systems for managing the fish waste and watering times in an aquaponic system.

### BACKGROUND

Aquaponics is a well-established agricultural method that combines aquaculture, which is the cultivation of aquatic organisms such as fish, with hydroponics, which is the cultivation of plants in a water-based nutrient-rich solution. This symbiotic system leverages the nutrient-rich water from the aquaculture component to feed the hydroponically-grown plants, creating a sustainable cycle. Despite the numerous benefits of aquaponics, including efficient nutrient utilization and reduced need for chemical fertilizers, there are several challenges associated with maintaining such systems.

One significant issue is the complexity and maintenance required for the aquaculture portion of the system. The inclusion of fish necessitates additional space and resources, which can be a limiting factor for many users, particularly those with smaller operational footprints. Managing fish health and dealing with fish waste adds layers of complexity that can impact the overall profitability and feasibility of the system. Fish waste, specifically the solids, can clog water delivery systems, leading to operational inefficiencies and the need for routine disposal. This not only increases labor costs but also poses challenges for maintaining optimal water quality and flow.

Furthermore, many aquaponics systems utilize ebb and flow racks, which are designed to support a wide range of plant types, including various greens. While these racks are beneficial for plant diversity, they require precise and consistent soak times to ensure optimal plant growth. The manual actuation of valves to control water flow from one tray to the next is labor-intensive and time-consuming. This manual process often results in inconsistent watering schedules, which can lead to irregular plant growth and reduced overall productivity.

Given these challenges, there is a clear need for advancements in aquaponics systems that address the issues of fish waste management, space utilization, and automation of water flow. An improved system that reduces or eliminates the clogging caused by fish solids, automates the watering process, and potentially produces additional valuable products would significantly enhance the efficiency and profitability of aquaponics operations. The present disclosure aims to address these and other related problems inherent in current aquaponics systems.

### SUMMARY OF EXAMPLE EMBODIMENTS

In some embodiments, an aquaponics system comprises a hydroponic system coupled to an aquaculture system, the hydroponic system configured to receive aquaculture water from the aquaculture system, the aquaculture system comprising a fish tank, a digestor assembly, a media bed, and a fill tank. In some embodiments, the digestor assembly comprises a skimmer tank and digestor tank. Water flows from the fish tank to the skimmer tank, with solids sinking in the skimmer tank and the separated water flowing to the media bed. The solids may then be released into the digestor tank, the digestor tank comprising an aeration stone, air pump, and an electric pump, all for churning contents. The churned contents become a suitable soil amendment, which may be dispensed through a spigot.

In some embodiments, the media bed comprises lava rock and/or other substances and materials configured to help bacteria break down fish waste. As the water filters through the media bed, which may be aided by a siphon, it passes into the fill tank. Water from the fill tank is then supplied to the grow racks. Once the water passes through the grow racks, the remaining water returns to the fill tank from one or more sump tanks of the grow racks. Water from the fill tank may also be pumped back to the fish tank should additional water be needed.

In some embodiments, the hydroponic system comprises grow racks, wherein the grow racks are stacked vertically and are configured to allow the flow of water from the top down. Tubing between each rack may be configured with one-way valves, and one or more solenoids may be used to drain the racks once the desired soak time has been reached. Once the water has passed through the racks, it drains into a sump tank, where a sump pump sends the water back to the fill tank. In some embodiments, the grow racks further comprise an automated control system, which may include a transceiver and a microcontroller or other processor, and may further include light-emitting diodes (LEDs) or other grow lights.

### BRIEF DESCRIPTION OF THE DRAWINGS

FIG. 1 illustrates a perspective view of an aquaponics system;

FIG. 2 illustrates an aquaculture system of an aquaponics system;

FIG. 3 illustrates a digestor assembly of an aquaculture system of an aquaponics system;

FIG. 4 illustrates a top perspective view of a skimmer tank of an aquaculture system of an aquaponics system;

FIG. 5 illustrates a top perspective view of a digestor tank of an aquaculture system of an aquaponics system;

FIG. 6 illustrates a side perspective view of a fill tank and media bed of an aquaculture system of an aquaponics system;

FIG. 7 illustrates a top, side, perspective view of a fill tank and media bed of an aquaculture system of an aquaponics system;

FIG. 8 illustrates a rear perspective view of a grow rack of a hydroponic system of an aquaponics system;

FIG. 9 illustrates a front elevation view of a grow rack of a hydroponic system of an aquaponics system;

FIG. 10 illustrates a detailed, top perspective view of a grow rack of a hydroponic system of an aquaponics system;

FIG. 11 illustrates a detailed, rear perspective view of a grow rack of a hydroponic system of an aquaponics system;

FIG. 12 illustrates a top perspective view of an aquaponics system;

FIG. 13 illustrates a top perspective view of an aquaculture system of an aquaponics system;

FIG. 14 illustrates a top plan view of an aquaculture system of an aquaponics system;

FIG. 15 illustrates a detailed, side perspective view of an aquaponics system;

FIG. 16 illustrates a bottom perspective view of a trough of a grow rack of a hydroponic system of an aquaponics system;

FIG. 17 illustrates a grow tower of a hydroponic system of an aquaponics system;

FIG. 18 illustrates a grow tower of a hydroponic system of an aquaponics system; and

FIG. 19 illustrates a detailed portion of half a grow tower of a hydroponic system of an aquaponics system.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

Aquaponics is a sustainable farming method that combines aquaculture (raising aquatic animals) with hydroponics (growing plants without soil). In an aquaponic system, the waste produced by aquatic animals, usually fish, provides nutrients for plants, and the plants help filter and purify the water, creating a closed-loop ecosystem. This integrated approach allows for the efficient and mutually beneficial cultivation of both fish and plants. Aquaponics includes several components that work together to form the system. First, an aquaculture component, which is generally a fish tank. The fish tank is where aquatic animals, such as fish or prawns, are raised. The fish produce waste in the form of ammonia-rich water, which serves as a nutrient source for the plants. Second, a hydroponic component which is the area where plants are cultivated. The hydroponic component may be a grow bed or a grow tower. In the case of a grow bed, it is usually filled with a soilless growing medium, such as gravel or expanded clay pellets, to support the plants. In the case of grow towers, the plants are in soilless grow plugs which hold the roots. The nutrient-rich water from the fish tank is circulated through the grow bed or grow towers, providing essential nutrients for plant growth.

Third, a plumbing system for circulating water through the system. A pump or pumps are used to circulate water from the fish tank to the grow bed and back, creating a continuous flow system. Plumbing is set up to facilitate the movement of water between the fish tank and the grow bed. Fourth, a biological filter, where nitrification occurs. Beneficial bacteria play a crucial role in aquaponics by converting ammonia, a waste product excreted by fish, into nitrites. Nitrates are the primary nutrient source for plants. Fifth, monitoring tools to help maintain the system. Regular monitoring of the pH level and electrical conductivity of the water is essential for maintaining optimal conditions for both fish and plants. Sixth, plants which are grown as produce and which clean the water. Various crops, such as herbs, vegetables, and fruits, can be grown in aquaponic systems. Plants absorb nutrients from the water, helping to filter and purify it for the fish.

As previously discussed, there is a need for an aquaponics system that addresses the issues of fish waste management, space utilization, and automation of water flow. An improved system that reduces or eliminates the clogging caused by fish solids, automates the watering process, and potentially produces additional valuable products would significantly enhance the efficiency and profitability of aquaponics operations. The aquaponics system disclosed herein solves these and other problems.

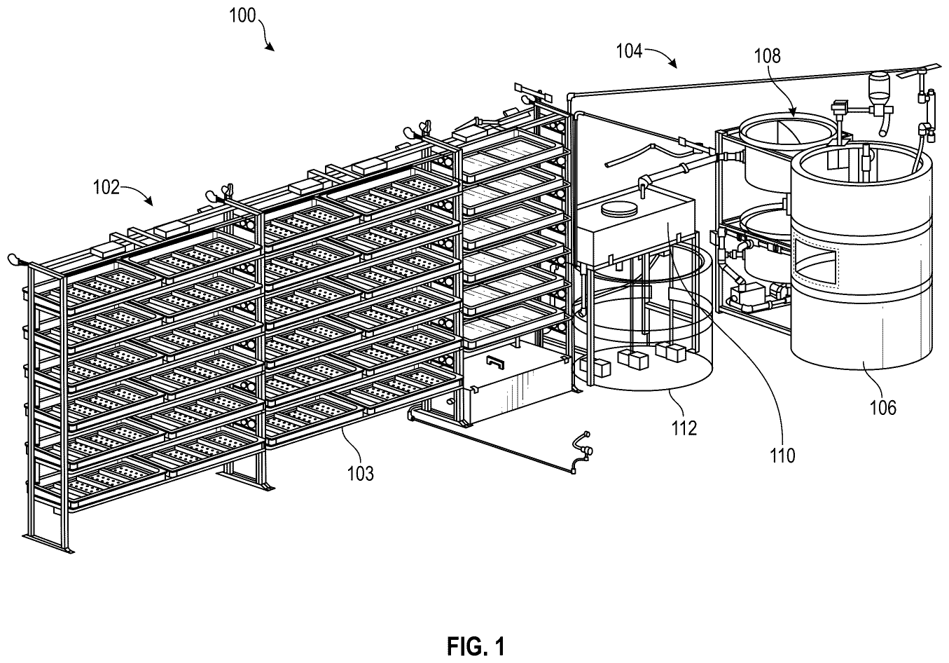

In some embodiments, as shown in FIGS. 1, an aquaponics system 100 comprises a hydroponic system 102 coupled to an aquaculture system 104. The aquaculture system 104 is configured to provide water to the hydroponic system 102 and, in some embodiments, comprises a fish tank 106, a digestor assembly 108, a media bed 110, and a fill tank 112. While described as a fish tank 106, it will be understood that it may contain both fish and/or shellfish. As understood, the fish and/or shellfish in the fish tank 106 create nutrient-rich water, via their waste, that is processed through the aquaculture system 104 before passing to the hydroponic system 102. The nutrient-rich water is then used by the plants in the hydroponic system 102 to grow more efficiently. Aspects of the aquaculture system 104 and the hydroponic system 102 will be further disclosed herein.

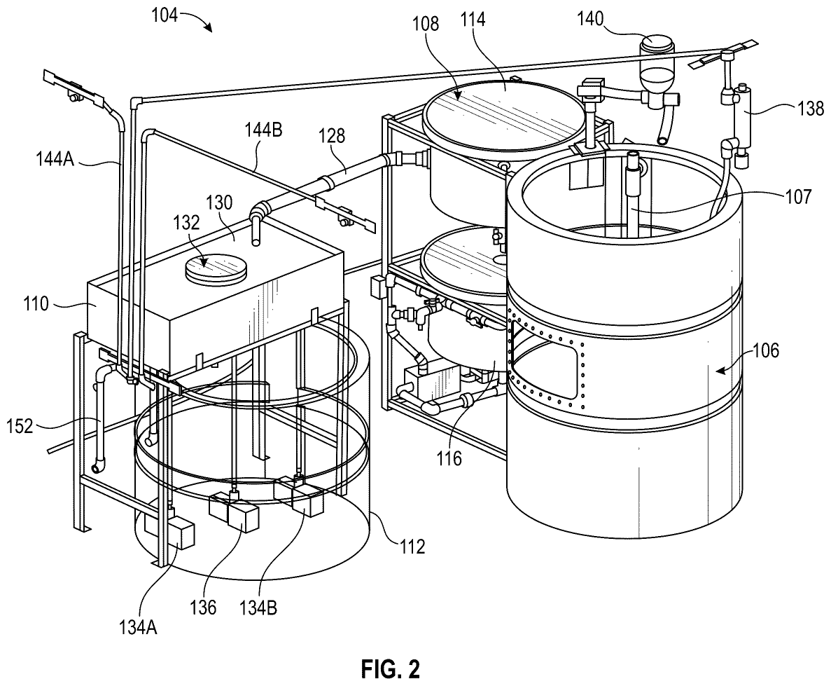

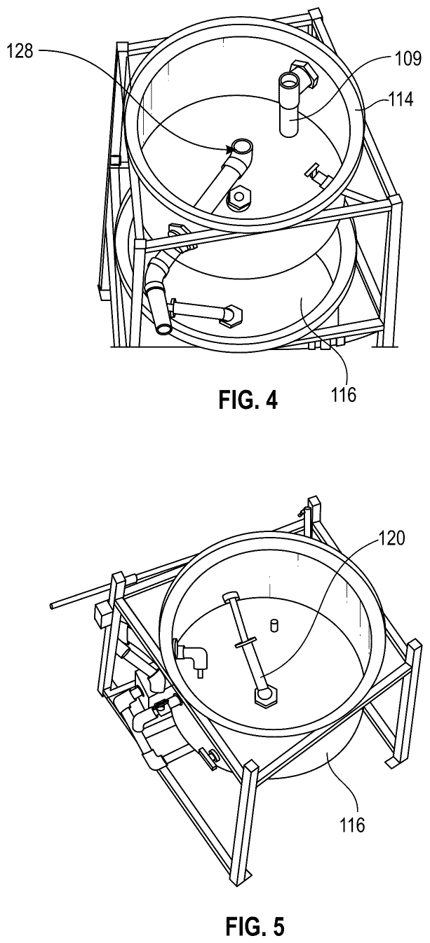

Referring now to FIGS. 2-5, the aquaculture system 104, in some embodiments, is shown in more detail. As shown, the digestor assembly 108 comprises a skimmer tank 114 and digestor tank 116, which may be stacked vertically. As the fish produce waste (e.g., excrement), it settles and accrues at the bottom of the fish tank 106. Some of the waste dissolves into the water, while other solids remain. The waste that dissolves into the water releases nitrogen, ammonia, and other byproducts into the water that helps create a more nutrient-rich water. This nutrient rich water, along with the remaining fish solids, is pumped, or otherwise flows, from the bottom of the fish tank 106, so as to collect the solids, to the skimmer tank 114, such as via a conduit 107. Taking the solid waste from the fish tank 106 is one way to keep the fish tank 106 in a condition in which the fish can remain healthy and thrive. In some embodiments, the water and waste may be continuously transported from the fish tank 106 to the skimmer tank 114. In some embodiments, the water and waste may be periodically transported from the fish tank 106 to the skimmer tank 114, such as at user set intervals or based upon a sensor reading, wherein the sensor is configured to determine the amount of solid waste accrued, or other metric as determined by a user.

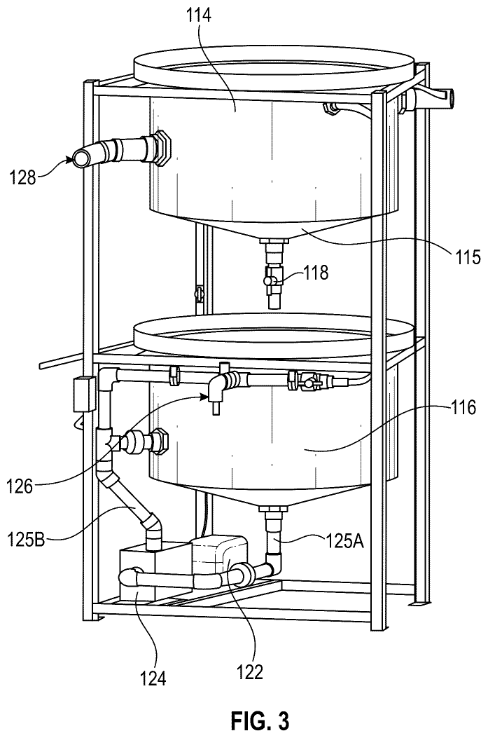

As the water and fish solids pass from the fish tank 106 via the conduit 107, they enter into the skimmer tank 114 via inlet 109. Once in the skimmer tank 114, the fish waste may continue to dissolve in the water. Beneficial microorganisms in the skimmer tank 114 ensure that nutrients are available in forms useful for plants. Such microorganisms may include Nitrosomonas bacteria which convert harmful ammonia (NH3) into nitrite (NO2), and Nitrobacter bacteria which convert nitrite (NO2) into nitrate (NO3). During this waste processing process, the solid waste becomes a sludge or slurry that settles to the bottom of the skimmer tank 114. The skimmer tank 114 may comprise a conical portion 115 (FIG. 3) to direct the solids (sludge or slurry) out of the skimmer tank 114 to keep the sludge or slurry from becoming stuck on the bottom of the skimmer tank 114.

The remaining solids (e.g., sludge/slurry) in the skimmer tank 114 may be released via a solids valve 118 into the digestor tank 116, where the solids may then be used to make a soil amendment. The solids valve 118 may be manually actuated or electronically actuated. In some embodiments, the solids valve 118 may programmed to actuate at timed intervals, or may be sensor based and triggered to actuate when a sensor reading meets or exceeds a predetermined threshold, such as a user defined threshold (e.g., level of solids in the digestor tank) for emptying the solids. Further, a pump (not shown) may be used aid in pumping solids from the skimmer tank 114 to the digestor tank 116.

Once the solids are released into the digestor tank 116, they may be further processed to create soil amendments, such as conditioner or other amendments. Accordingly, the digestor tank 116 comprises an aeration stone 120 and an air pump 122 coupled to the aeration stone 120, and a recycling pump 124, all of which are used for churning the contents of the digestor tank 116. While not shown, it will be appreciated that other agitators and/or mixers (e.g., motor driven arms, beaters, etc.) may be used so as to further agitate and mix the waste sludge/slurry. In one example, the recycling pump 124 may cycle the contents of the digestor tank 116 via conduits 125A-B.

In addition to aeration and churning, microbes, bacteria, and/or fungi may be added to the digestor tank 116. The addition of microbes, bacteria, and/or fungi may be performed manually by a user (e.g., dumping directly into the digestor tank 116), or may be added via a valve coupled to an exogenous microbe tank. The valve may be manually actuated by a user, or may be electronic (e.g., solenoid valve) and programmable to dispense a predetermined amount of microbes into the digestor tank. The churning, aeration, and microorganisms convert the remaining solids into a beneficial byproduct, such as soil amendments, such as soil conditioner. This resulting soil amendment may be dispensed through a spigot 126 or other valve or outlet. Therefore, it will be appreciated that the digestor assembly 108 overcomes limitations in the art by turning remaining fish excrement and waste into a valuable product-soil amendments. This soil amendment produces numerous advantages, including a higher yield per acre of crops, allowing for less dependence and use of other fertilizers, increasing water retention (meaning less water is needed for crops in soil treated with the amendment), restoring soil health, adding beneficial microbes to crops, and may be used in commercial or non-commercial settings for both food production and landscape. Accordingly, not only does the digestor assembly 108 produce valuable soil amendments, but it also aids in keeping the fish tank 106 cleaner and healthier for the fish.

Additionally, while the digestor assembly 108 is described as being a component of the aquaculture system 104, it will be understood that it need not be an integral assembly, but may be an independent assembly capable of being added to any number of aquaculture systems in the art. In other words, it is specifically contemplated herein that the digestor assembly 108 may be retrofitted to prior art aquaculture systems and/or be interposed or otherwise utilized in prior art aquaponics systems.

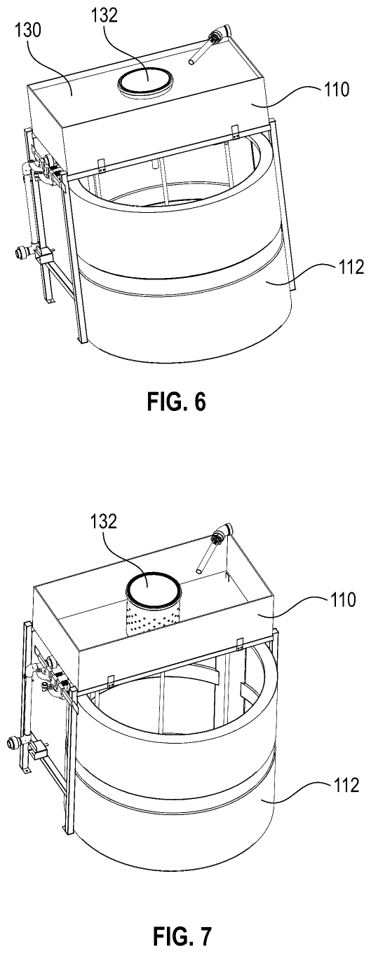

Returning now to the skimmer tank 114, and as shown in FIG. 2, the nutrient rich, solid-free water (or mostly solid-free) flows to the media bed 110. The nutrient-rich water flows from the skimmer tank 114 to the media bed 110 via a conduit 128. The water flow from the skimmer tank 114 to the media bed 110 may be gravity fed or pumped. As best seen in FIGS. 6-7, the media bed 110 comprises lava rock 130 and/or other media to aid the bacteria and microorganisms in further breaking down the fish waste present in the water. A bell siphon 132 (or other siphon) positioned within the lava rock 130 ensures that the nutrient-rich water passes through the lava rock 130 as it is siphoned into the bell siphon 132 to pass to the fill tank 112. The lava rock 130 is removed from FIG. 7 to illustrate the bell siphon 132 more clearly. Additionally, the fill tank 112 is shown transparent in FIGS. 1-2 for ease of illustrating its interior components.

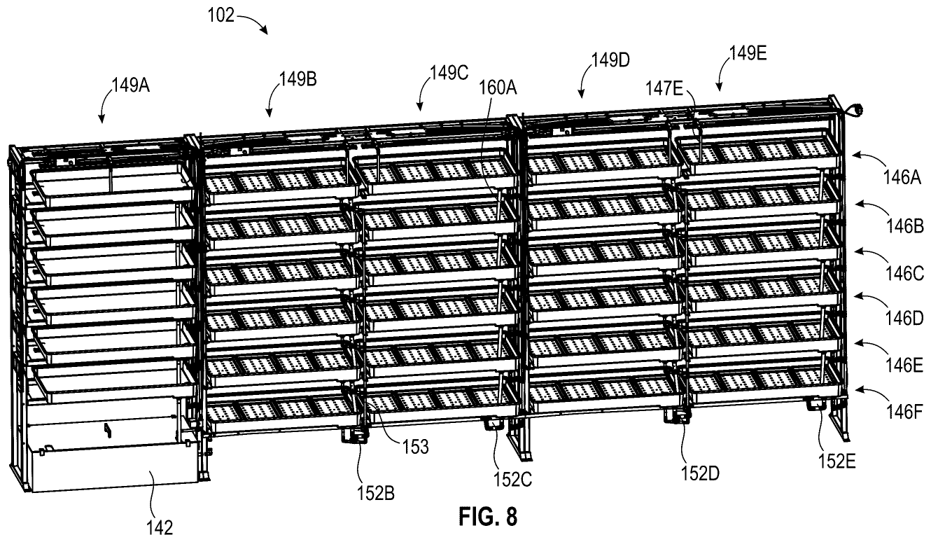

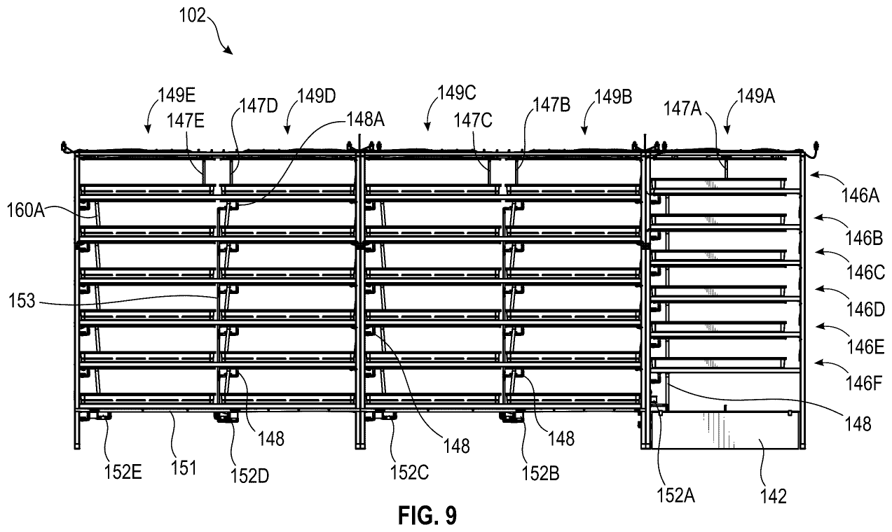

As best seen in FIG. 2, the nutrient-rich water from the fill tank 112 is then supplied to the hydroponic system 102 via one or more rack pumps 134A-B. A fish tank pump 136 may also supply water back to the fish tank 106, which may pass through a UV clarifier 138 or other filter. Additionally, the fish tank 106 may comprise an automated feeder 140. Once the nutrient-rich water passes through the hydroponic system 102 (as will be discussed next herein), the remaining water returns to the fill tank 112 from one or more sump tanks 142 (FIG. 8) of the hydroponic system 102. As a result, the nutrient-rich water can continue to cycle to ensure the plants uptake needed nutrients and that water is constantly recycled through the fish tank 106 to keep it in optimal condition as well.

In some embodiments, the hydroponic system 102 comprises grow racks 103 are stacked vertically and are configured so that water flows from the top down. In other words, as shown in FIG. 2, water from the fill tank 112 is pumped through one or more supply conduits 144A-B via the one or more pumps 134A-B to the hydroponic system 102. It will be appreciated that while only one hydroponic system 102 is shown, it will be appreciated that more than one system (e.g., plurality of racks 103) may be used, and is specifically contemplated herein. For example, supply conduit 144A may supply a first hydroponic system 102 while supply conduit 144B may supply a second hydroponic system, which may be the same or different in configuration from the first hydroponic system 102.

Referring to FIG. 8, the nutrient-rich water flows from the supply conduit 144A to the hydroponic system 102, where it is dispensed into the top row 146A of the grow racks 103 of the hydroponic system 102 via an inlet 147A-E corresponding to each column 149A-E. As the top row 146A becomes full, it overflows into the next row 146B, and so on into subsequent rows 146C-F, until all the rows 146A-F of the hydroponic system 102 are full of nutrient-rich water from the fill tank 112. Each column 149A-E and row 146A-F comprises a respective drain tube 148 (for conciseness and ease of viewing, only a select number of drain tubes 148 are labeled in the Figures). A one-way valve 150 may couple each drain tube 148 to another of each respective row 146A-F and column 149A-E to ensure a unidirectional flow downward of water.

For example, once the plants in the grow racks 103 of the hydroponic system have soaked the desired amount of time (as determined by a user based upon the plants being cultivated), one or more solenoid valves 152A-E, each corresponding to a respective column 149A-E, actuates and allows water to flow through the plurality of drain tubes 148 and to a collective sump conduit 151 and into the sump tank 142. A sump pump (not visible) then pumps the water back to the fill tank 112 via conduit 154 (FIG. 2), where it may be cycled through the hydroponic system 102 once more and/or be pumped back to the fish tank 106.

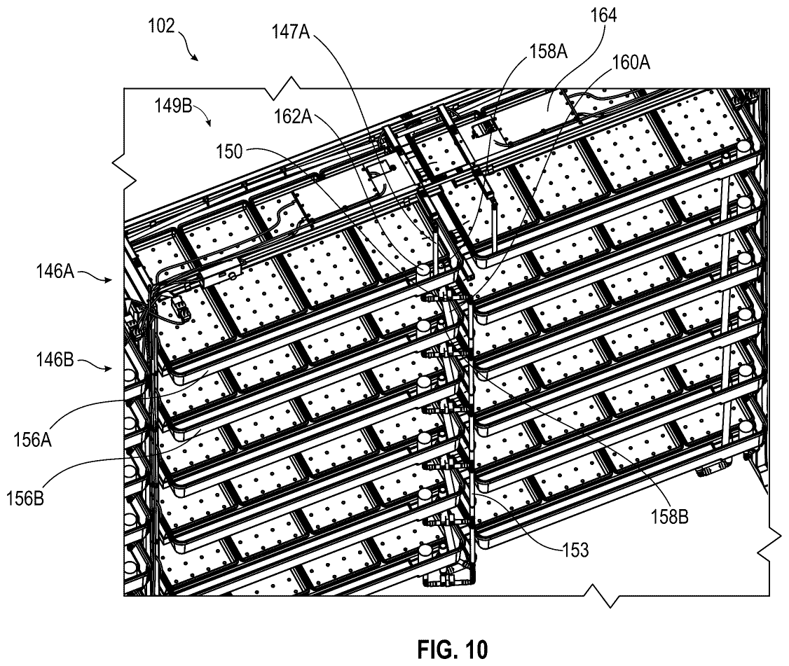

FIG. 10 illustrates a detailed top perspective view of a portion of the hydroponic system 102. As shown, nutrient-rich water flows through inlet 147A to the first tray 156A of the first row 146A of column 149B. The water continues to fill the first tray 156A until a predetermined threshold is reached. In this example, the predetermined threshold is determined by the height of an overflow outlet 158A. Water then flows through the overflow outlet 158A through overflow tube 160A to the second tray 156B of the second row 146B. Like the first tray 156A, the second tray 156B (and subsequent trays on each row 146C-F) comprises an overflow outlet 158B to allow water to flow to the subsequent rows 146C-F once the threshold is reached. As a result, each row 146A-F is able to fill with nutrient-rich water, in turn, until all rows 146A-F are filled with nutrient-rich water.

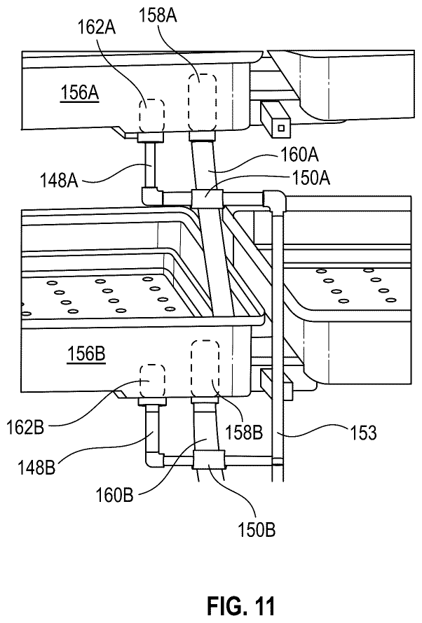

FIG. 11 illustrates an enlarged portion of the hydroponic system 102 to better illustrate the water flow between each row. For example, once the water in first tray 156A reaches the top of overflow outlet 158A, water then flows to second tray 156B via overflow tube 160A. Once second tray 156B is full with water, water then flows through overflow outlet 158B to the next tray via overflow tube 160B, and so on until all trays are filled in the grow rack 103 of hydroponic system 102. Once the desired soak time has occurred, the rows 146A-F may each be emptied via a respective drain.

For example, first tray 156A comprises a first drain 162A coupled to a first drain tube 148A. The drain tube 148A comprises a one-way valve 150A (e.g., check valve) so that water does not flow through the drain tube 148A to the trunk line 153 until the one-way valve 150A is actuated by a respective solenoid valve 152A-E (not visible in this Fig.). Likewise, second tray 156B comprises a second drain 162B coupled to a second drain tube 148B, the second drain tube 148B comprising a one-way valve 150B prior to joining the trunk line 153. While the one-way valves 150A-B are illustrated as overlapping the overflow tubes 160A-B, respectively, it will be understood that the one-way valves 150A-B only function on drain tubes 148A-B, respectively, and do not affect the overflow tubes 160A-B. The water in the trunk line 153 flows to the one or more sump tanks 142, where it can then be pumped back to the aquaculture system 104.

Accordingly, in some methods of use, a user will fill the fish tank 106 with water and fish/shellfish. The fish may be fed automatically using an automated feeder 140. Water and fish waste then flows from the fish tank 106 into the skimmer tank 114 of the digestor assembly 108. Undissolved fish waste, which may also be in the form of a sludge or slurry, rests on the bottom of the skimmer tank 114, while the water containing dissolved waste, which is largely solid free, flows to the media bed 110. The remaining fish solids in the skimmer tank 114 can be released to the digestor tank 116, where the fish waste solids are churned and aerated to create soil amendments. Additional bacteria (e.g., h2organix) may be added the digestor tank 116 to promote the breakdown of the fish waste. The resulting soil amendment may then be used or sold. Turning remaining fish waste into a usable, valuable product overcomes limitations in the art.

The water containing dissolved fish waste filters through lava rock 130 or other media in the media bed 110 and is siphoned through the lava rock 130 into a fill tank 112, resulting in nutrient-rich water filling the fill tank 112. The nutrient-rich water in the fill tank 112 is then pumped via one or more pumps 134A-B to the hydroponic system 102. The nutrient-rich water is distributed from the top row 146A to the bottom row 146F of the grow racks 103 of the hydroponic system 102 via one or more respective overflow outlets 158A-B and overflow tubes 160A-B at each row. The water remains in the grow racks 103 for a predetermined amount of time before being automatically released via one or more solenoid valves 152A-E, each solenoid valve coupled to a trunk line 153, with row containing one or more drain tubes 148A-B coupled to the trunk line 153. Accordingly, when the solenoid valves 152A-E are actuated, the one-way valves 150A-B are actuated, allowing water to flow from each respective drain line 148A-B to the trunk line 153 and to the sump tank 142. The water collects in a sump tank 142, where it is then pumped back to the fill tank 112.

The pumps and valves of the aquaponics system 100 may be controlled via a timer, smart plugs, or via a master controller. If using smart plugs, each pump and siphon can be plugged into a respective smart plug to allow a user to control the pumps using software provided by the third-party smart plugs. In some embodiments, the master controller may comprise a microcontroller (or other processor) and a transceiver. For example, a wireless transceiver may be used to transmit data to and from the microcontroller to a user, such as on an internet-connected device (e.g., smartphone, tablet, computer, etc.). In some embodiments, the user may program the various pumps and valves using the internet-connected device as an input (e.g., smartphone application). In some embodiments, the master controller may comprise a display and input/output mechanisms (touchscreens, buttons, knobs, etc.).

In some embodiments, data may be collected, stored, and/or transmitted to a user. For example, in some embodiments, the aquaponics system 100 comprises one or more sensors to provide status information to a user. For example, tank level sensors may be used to monitor the water level in the fish tank 106, skimmer tank 114, fill tank 112, sump tank 142, etc. and to notify a user at certain triggering events (e.g., water level below a predetermined threshold, clogged filters, pump malfunction, etc.). Additional sensors may also be used to determine the conditions of the water in the various tanks, including temperature, PH balance, or other metrics. A solid waste sensor (e.g., weight, height) may also be used to determine when the solid waste in the skimmer tank 114 has reached a predetermined threshold, requiring that it be emptied into the digestor tank 116. Additional sensors, such as temperature, humidity, etc. may also be used to provide additional system insights and warnings. The microcontroller may be configured to turn components (e.g., pumps, valves, lights, fans, etc.) on/off depending on the current conditions and the programming of the user. The status of all components may be transmitted to a user via the transceiver, which may use Bluetooth, Wi-Fi, Cellular, or other network protocols to transmit and receive data.

Additionally, as best seen in FIG. 10, the hydroponic system 102 may comprise full-spectrum grow lights 164 (e.g., LEDs), as well as a plurality of fans, which may be at each row 146A-F to promote healthy leaf transpiration, among other components.

Therefore, it will be appreciated that the aquaponics system 100 disclosed herein solves the need for advancements in aquaponics systems that address the issues of fish waste management, space utilization, and automation of water flow. The aquaponics system 100 reduces or eliminates the clogging caused by fish solids, automates the watering process, and produces additional valuable products that significantly enhance the efficiency and profitability of aquaponics operations, overcoming limitations of the prior art.

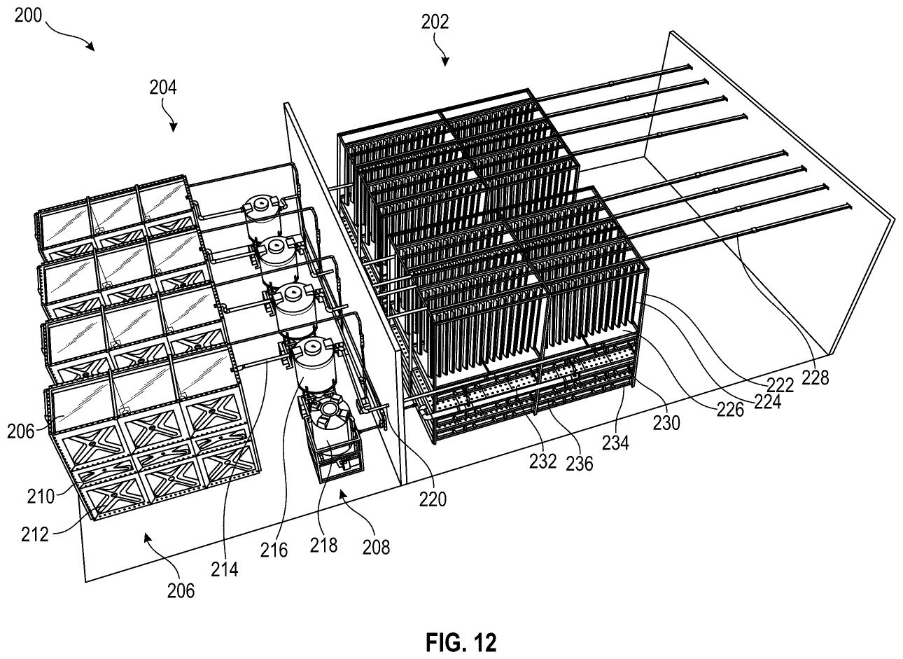

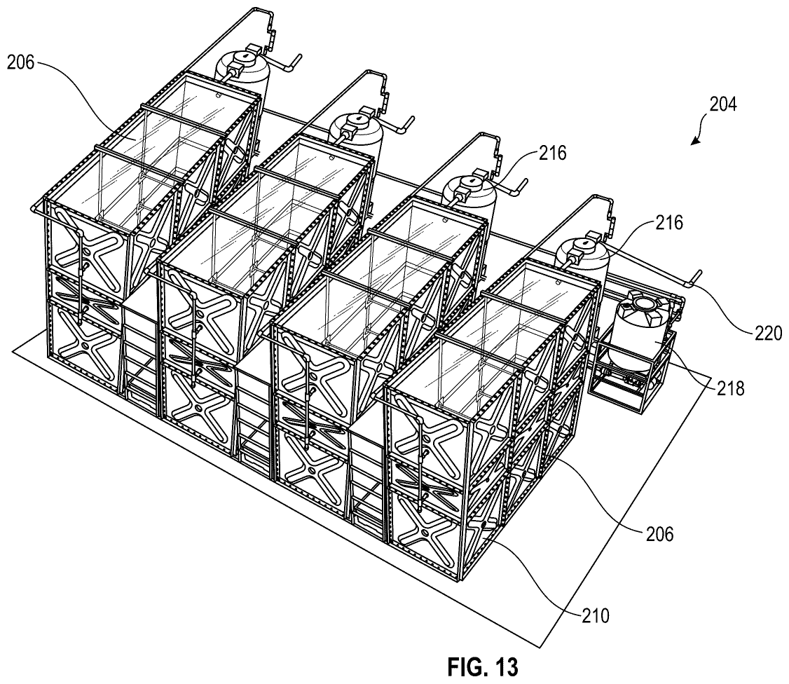

Referring now to FIGS. 12-19, in some embodiments, an aquaponics system 200 is disclosed. As shown, the aquaponics system 200 comprises a hydroponic system 202 and an aquaculture system 204. The aquaculture system 204 may comprise one or more fish tanks 206 and a digestor assembly 208. The fish tanks 206 are designed to be modular. For example, the fish tanks 206 are made from panels 210 that fit together to create a watertight tank. The panels 210 are made from a strong rigid material to ensure the fish tank 206 maintains its shape. Such materials include steel, stainless steel, aluminum, anodized aluminum, plastic, or composite materials. The panels 210 are fastened together using any manner of fasteners. In some embodiments, the fasteners are nuts and bolts.

As the panels 210 are fastened together, seals are secured between the panels 210 to ensure that water does not seep out of the tanks 206. The panels 210 can be arranged in many possible configurations. The chosen configuration depends on the desired dimensions of the tank 206. The tanks 206 may also include cross members 212 to provide strength to the completed tank 206. In some embodiments, the fish tank 206 provides a current against which the fish can swim. The current may be provided by water being recirculated into the fish tank 206.

Within each tank 206 is an outlet 214 that transports water and waste from the bottom of each tank 206 to the digestor assembly 208. As the fish are cultivated in the fish tank(s) 206, the fish produce waste. The solid waste falls to the bottom of the fish tank 206. When the waste leaves the fish into the water of the tank 206, the waste begins to dissolve in the water. Taking the remaining solid waste from the fish tank 206 is one way to keep the fish tank 206 in a condition in which the fish can be healthy. In some embodiments, and as discussed earlier herein, the water and waste may be continuously transported from the fish tank 206. In some embodiments, the water and waste may be periodically transported from the fish tank 206.

The water and waste are transported from the fish tank 206 to the digestor assembly 208, which processes the water and waste. For example, water and waste passes from the fish tank 206 to a skimmer tank 216 of the digestor assembly 208. While being held in the skimmer tank 216, the waste continues to dissolve in the water. As the waste dissolves, nitrogen is released into the water. Beneficial microorganisms may be added to the skimmer tank 216 to ensure that nutrients are available in forms useful for plants. Such microorganisms include Nitrosomonas bacteria, which convert harmful ammonia (NH3) into nitrite (NO2), and Nitrobacter bacteria, which convert nitrite (NO2) into nitrate (NO3).

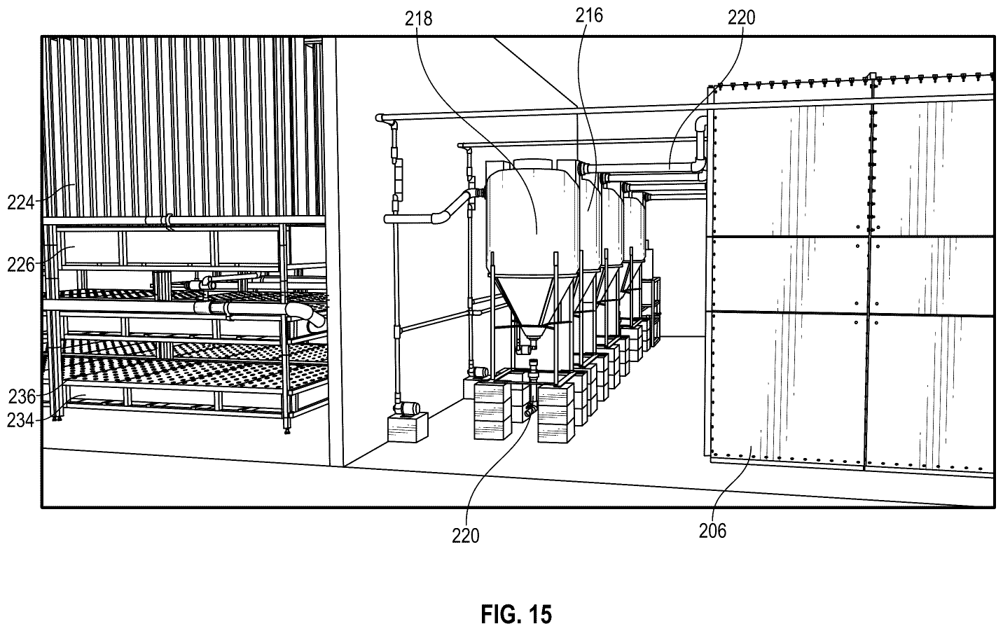

During the waste processing process, the solid waste becomes a sludge or slurry that settles to the bottom of the skimmer tank 216. This sludge or slurry may be transported to a digestor tank 218. As shown, multiple skimmer tanks 216 may each feed into a single digestor tank 218. However, it will be appreciated that multiple digestor tanks 218 may be used, or that the same configuration of the digestor assembly 108 previously described herein may be used. Additional microorganisms may be added to the digestor tank 218 to further break down the waste, which aids in the release of other nutrients. As the waste in the digestor tank 218 breaks down further, water and nutrients may be siphoned off the top and transported back to the skimmer tanks 216. The remaining waste slurry may be removed, such as via a valve and conduit 220 (FIG. 15) coupled to the bottom of the digestor tank 218. This concentrated slurry can be used as agricultural amendments which can be added to a garden or to large scale agricultural farms.

The nutrient-rich water that is siphoned from the top of the skimmer tanks 216 may be pumped to the hydroponic system 202 via conduit 220. As shown, the hydroponic system 202 includes frame 222 which supports troughs and grow towers. The grow towers 224, hang over troughs 226 filled with water. In some embodiments, there are two levels of troughs 226. The grow towers 224 are attached to a trolley beam 228 so the towers 224 can slide through the hydroponic system 202. This allows the plants to be easily moved as they grow. For example, starting at a first end, the plants in the towers 224 are small. When the towers 224 reach the far end of the frame 222, the plants are fully grown.

The grow towers 224 may be made of two halves, wherein the first half and second half mirror each other. The two halves form a vessel with a cavity in the middle between them. The cavity acts as a flow channel to carry water down the tower. Along each vertical side of each tower are plant plug holders which hold plant plugs. The plant plug holders are angled to keep the plugs in the tower. The plant plug holders are connected to the cavity in the center of the tower so that water can flow down the central cavity or flow channel and through the plant plugs. The plant plugs are also angled so that as the water flows down the flow channel the water flows down and through the plant plugs. Keeping the water flowing down is beneficial so that water is not directed out of the tower 224 through the plant plugs.

In some embodiments, the plant plug holders on a first edge are offset from the plant plug holders on a second edge. For example, the plant plug holders on a first edge are not horizontally level with the plant plug holders on a second edge. In some embodiments, there are between six and sixteen plant plug holders on the first edge, and there are between five and fifteen plant plug holders on the second edge. At the top of the tower 224 the two halves form a basin. The basin collects water and passes the water from the basin into the cavity or flow channel of the tower 224. The water passes from the basin through apertures into the flow channel.

The apertures are sized so the water flows at a predetermined rate into the flow channel. The water flowing through the tower 224 is the nutrient-rich water received from the one or more skimmer tanks 216. The water or nutrient solution continues through the system and falls from the towers 224 to a first trough 226. The first trough 226 may also be used to grow worms. In embodiments where the first trough 226 is used for vermiculture, the first trough 226 includes media in which worms are easily grown. Media through which the worms can easily move is best for the worms. In some embodiments, the media is lava rock. The first troughs 226 may also be used to grow shellfish.

In some embodiments, water and/or waste may be transported from the digestor tank 218 to the first trough 226. This may be beneficial for vermiculture, as the nutrient solution is likely to contain scraps from the digestor tank 218, which may include solid fish waste, semisolid fish waste, fish scales, and/or uneaten fish feed. The presence of these scraps is the food on which the worms subsist. The worms and their environment provide another filter for the water or nutrient solution before it is applied to the plants. The worms help with the nutrient cycling in the system. Additionally, the worms produce casings which can be removed and used in traditional plant growing systems or can be added to the nutrient slurry removed from the digestor tank 218. In implementations with shellfish, the shellfish also feast on the scraps.

The first trough 226 may be coupled to a second trough 230. The water or nutrient solution is passed from the first trough 226 to the second trough 230. The second trough 230 also includes plants grown on rafts, such as raft 232. The roots hang down through the raft 232 into the water or nutrient solution in the second trough 230. The roots further filter the water. In some embodiments, the water passes from the second trough 230 back to the fish tanks 206. The filtered water has been cleaned and is ready for use in the fish tank 206. In some embodiments, there are more troughs which are used to grow plants. For example, the water passes from a second trough 230 to a third trough 234. The third trough 234 may also grow plants on rafts, such as raft 236. The third trough 234 may also grow shellfish beneath the rafts 236.

In some embodiments, grow lights are attached to the bottom of the first trough 226 providing light to the plants on the rafts 232 in the second trough 230. In embodiments with more troughs, grow lights may be attached to the bottom of each trough to provide light to the plants on the next trough down.

In addition to growing plants on rafts in each trough, shellfish can be grown in the troughs. By including shellfish in the troughs, the food density of the aquaponics system 200 is increased. An increased food density is more efficient to grow and bring to harvest.

In some embodiments, the individual components of the aquaponics system 100/200 may be used separately. For example, the aquaponics system 100/200 could be used solely for growing fish and without being connected to the digestor assembly 108/208, or to the hydroponic system 102/202. The aquaculture system 204 includes aquaculture tanks (e.g., fish tanks 206). The aquaculture tanks are used to cultivate aquatic species such as fish. If the aquaculture system 204 is to be used in conjunction with other systems, such as a hydroponic system 202, it is preferable that the aquaculture system be a freshwater aquaculture system. This is because the cultivation of saltwater species in a saltwater system necessitates the use of saltwater. Plants generally do not do well with saltwater, so any system utilizing saltwater would need to also incorporate desalinization devices and processes to get the water to a usable form for plants.

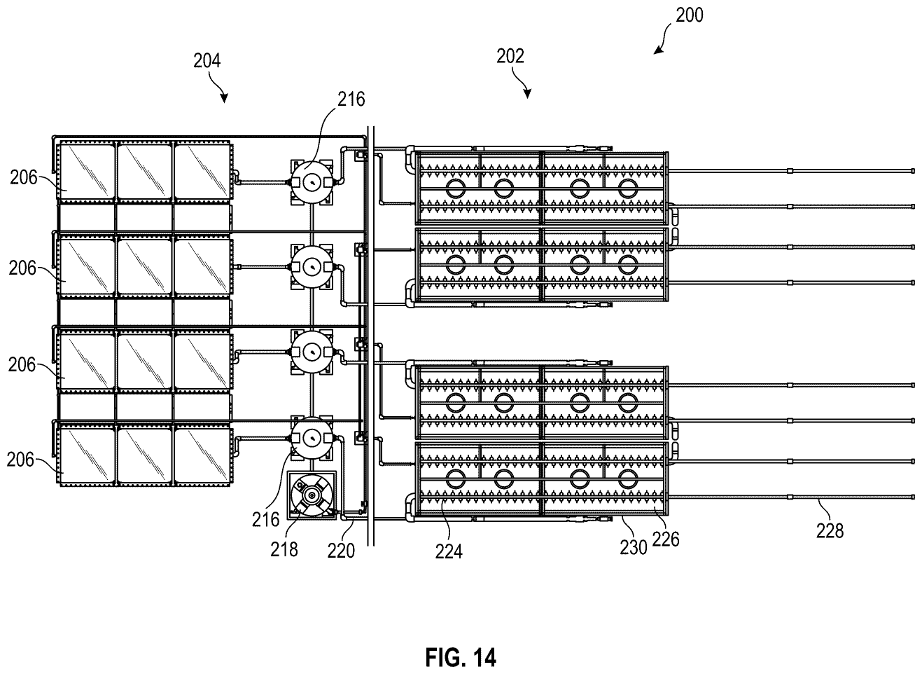

FIG. 14 is a top plan view of the aquaponics system 200. The fish tanks 206 are used to raise fish and/or shellfish. The waste from the fish is transported from the fish tanks 206 to the skimmer tanks 216, which is configured for waste settling and nutrient concentration. In the skimmer tanks 216, the solid waste settles to the bottom of the container. While the waste is in the skimmer tanks 216, the nutrients diffuse from the waste into the water. Additionally, microorganisms in the skimmer tank 216 break down the waste, releasing more nutrients. The top portion of water from the skimmer tanks 216 is transported to the hydroponics system 202. The remaining settled waste, which becomes a sludge or slurry, is transferred to one or more digestor tanks 218.

The sludge or slurry is further broken down in the digestor tank 218 by microorganisms. The further breakdown of the waste sludge or slurry releases more nutrients. In some embodiments, water is added to the digestor tank 218 to aid further diffusion of nutrients into the water. This nutrient solution may be transferred back to the one or more skimmer tanks 216. The nutrient solution may then be transferred from the skimmer tanks 216 to the hydroponic system 202. The remaining sludge or slurry may be removed from the digestor tank 218 through a valve. In some embodiments, as discussed earlier herein, the digestor tank 218 may be configured to mix and churn the sludge/slurry to develop agricultural amendments, although such a configuration is not required.

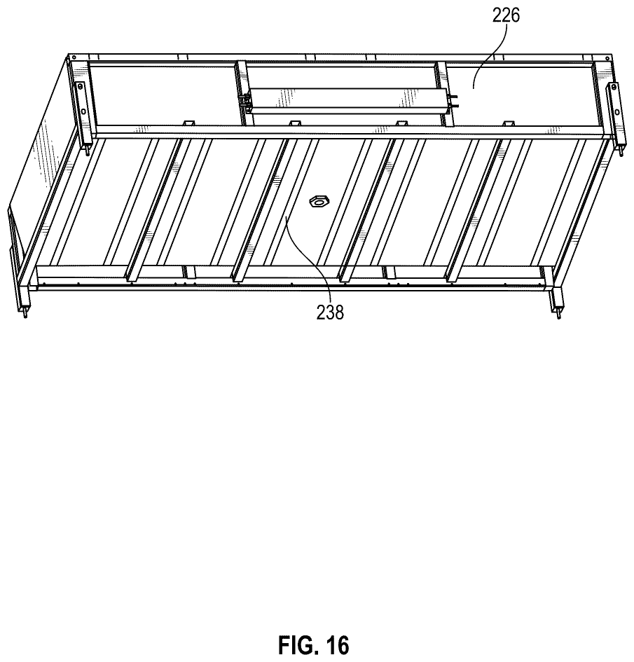

As best seen in FIG. 16, grow lights 238 may be coupled to the underside of each trough 226 to provide light to the respective plants thereunder. In some embodiments, the grow lights 238 are LED light strips that span the width of the trough 226. The grow lights 238 may be attached to the trough 226 in any manner that will secure them to the trough 226. For example, in some embodiments, the grow lights 238 may attach to the trough 226 with adhesive. The grow lights 238 being attached directly to the trough 226 offers some benefits for the grow lights 238.

For example, the grow lights 238 may run hot and need to dissipate that heat so the electronics attached to the grow lights 238 do not melt or overheat. By attaching the grow lights 238 to the trough 226, the trough 226 functions as a heat sink. The heat from the grow lights is therefore dissipated into the trough 226 and into the water within the trough 226. In some embodiments, the trough 226 may itself function as a heat sink when made of metal, as the heat would pass into the metal and be conducted through the trough 226. The addition of water in the trough 226 further enhances the ability of the trough 226 to dissipate heat as the heat passes into the water as well as the trough 226. The troughs 226 are sufficiently large that the heat from the grow lights 238 would have a limited effect on the temperature of the water. In some embodiments, the heat generated from the grow lights 238 is beneficial, as increasing the temperature of the water may increase the growth rate of the plants grown using water from the trough 226.

Another benefit of the grow lights 238 being directly attached to the trough 226, is the time and cost of replacement when the grow lights 238 need to be replaced. The lights may need to be replaced because they wear out, or from damage. Removal of the grow lights 238 is a simple process of detaching the grow lights 238 from the electronics and removing the grow lights (e.g., LED strip) from the trough 226.

The hydroponic system 202 of the aquaponics system 200 includes grow towers 224. In the prior art, plant plug holders in the towers mirror one another, meaning that plant plug holders on one side of each tower are on the same vertical level as plant plug holders on the other side of the tower. By mirroring the plant plug holders, each tower held an even number of plants. For example, the towers could hold twenty plants. Additionally, the configuration of the channel within the tower caused water to flow out of the plant plug holders. The water flowing out of the plant plug holders waterlogged the plants and pushed the grow medium of the plant plug out of the plant plug holders.

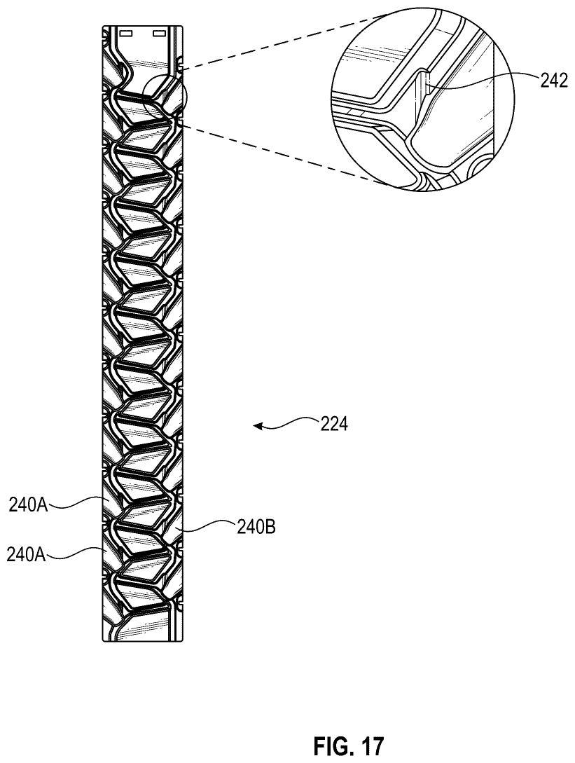

In contrast, FIG. 17 illustrates a new design that overcomes the limitations of the prior art. For example, grow tower 224 comprises plant plug holders 240A on a first edge that are offset from the plant plug holders 240B on a second edge. This configuration enables each grow tower 224 to have twenty-one plant plug holders, such as eleven on a first edge and ten on a second edge. The channel 242 within the tower 224 is designed to enable water to trickle or flow down the channel 242 and moisten the plant plugs without getting the plant wet and without causing the grow medium to be pushed out of the respective plant plug holders 240A-B. The geometry of the channel 242 and the plant plug holders 240A-B causes the water or nutrient medium to flow downward, without flowing out of the plant plug holders 240A-B.

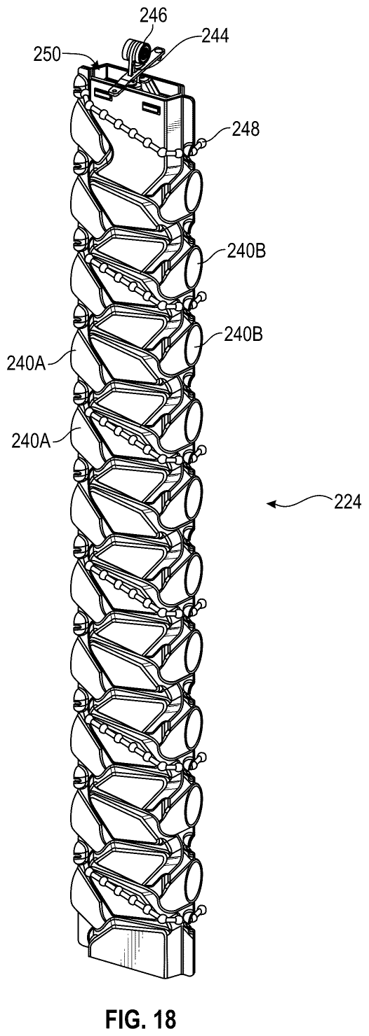

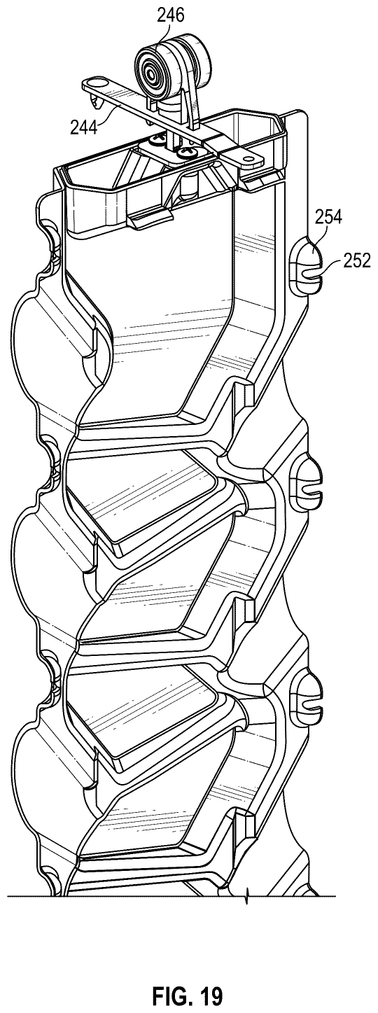

FIGS. 18-19 illustrate more detail of the grow towers 224. As discussed earlier, the grow towers 224 may be coupled to a trolley beam 228 so the grow towers 224 can be maneuvered to varying positions. The grow towers 224 include a trolley 244 which includes rollers or wheels 246. When the grow towers 224 are positioned at the far end (e.g., distal to the aquaponics system 204) of the trolley beam 228, the plants are fully grown. In some embodiments, the grow towers 224 are made of two halves which may be coupled together, such as by using flexible straps 248.

The first half and second half mirror each other and form a vessel with a cavity 250 in the middle between them. The cavity 250 acts as a flow channel to carry water down the grow tower 224. Along each vertical side of each grow tower 224 are plant plug holders 240A-B, respectively, which hold plant plugs. The plant plug holders 240A-B are angled to keep the plugs in the grow tower 224. The plant plug holders 240A-B are connected to the cavity 250 in the center of the grow tower 224 so that water can flow down the central cavity 250 or flow channel and to the plant plugs. Keeping the water flowing down is beneficial so that water is not directed out of the grow tower 224 through the plant plug holders 240A-B.

In some embodiments, as shown, the plant plug holders 240A on a first edge are offset from the plant plug holders 240B on a second edge. In other words, the plant plug holders 240A on a first edge are not horizontally level with the plant plug holders 240B on a second edge. In some embodiments, there are between six and sixteen plant plug holders 240A on the first edge, and there are between five and fifteen plant plug holders 240B on the second edge.

In some embodiments, the top of the cavity 250 may comprise a plate with apertures (or other flow restriction device). The apertures are sized so the water flows at a predetermined rate into the cavity 250 and flow channel. The water flowing through the tower 224 may be a nutrient solution. The nutrient solution may be received from aquaculture system 104/204.

FIG. 19 illustrates one half of a grow tower 224. The grow towers 224 include a trolley 244 which includes rollers or wheels 246. The flexible straps 248 secure to strap slots 252, which may be within a protrusion 254.

Therefore, it will be appreciated that the aquaponics system 100/200 disclosed herein solves the need for advancements in aquaponics systems that address the issues of fish waste management, space utilization, and automation of water flow. The aquaponics system 100/200 reduces or eliminates the clogging caused by fish solids, automates the watering process, and produces additional valuable products that significantly enhance the efficiency and profitability of aquaponics operations, overcoming limitations of the prior art. Additionally, the grow towers disclosed herein increase the number of plants per grow tower, while also overcoming the limitations in prior art towers.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. An aquaponics system, comprising:
an aquaculture system coupled to a hydroponics system, the aquaculture system comprising:
a fish tank,
a digestor assembly coupled to the fish tank,
a media bed coupled to the digestor assembly, and
a fill tank coupled to the media bed;
wherein nutrient-rich water is configured to flow from the fill tank to the hydroponic system.

2. The aquaponics system of claim 1, wherein the digestor assembly comprises a skimmer tank and a digestor tank.

3. The aquaponics system of claim 2, wherein the skimmer tank comprises an outlet conduit configured to provide water to the media bed, and a solids valve configured to release undissolved solids into the digestor tank.

4. The aquaponics system of claim 2, wherein the digestor tank comprises an aeration stone coupled to an air pump, a recycling pump configured to cycle contents of the digestor tank, and a spigot to release the contents of the digestor tank.

5. The aquaponics system of claim 1, wherein the media bed comprises a bell siphon surrounded by lava rock.

6. The aquaponics system of claim 5, wherein the bell siphon is configured to siphon water through the lava rock and into the fill tank.

7. The aquaponics system of claim 1, wherein water flows from the fill tank to the hydroponic system via one or more inlets, the one or more inlets configured to provide the water to a first row of a plurality of rows, the water configured to flow to each subsequent row via respective overflow tubes.

8. The aquaponics system of claim 1, wherein the hydroponic system comprises one or more grow racks that further comprise at least one solenoid valve for actuating one-way valves of respective drain tubes.

9. The aquaponics system of claim 8, wherein each drain tube is coupled to a trunk line.

10. The aquaponics system of claim 9, wherein the trunk line is coupled to a sump tank, the sump tank coupled to the aquaculture system.

11. The aquaponics system of claim 1, wherein the hydroponic system comprises grow racks and grow lights.

12. An aquaponics system, comprising:
a hydroponic system comprising one or more grow racks, each grow rack comprising:
a plurality of columns, each column comprising a plurality of rows, a plurality of overflow tubes, each overflow tube interposed between each row of each column,
each column and each row comprising a respective drain tube, each drain tube coupled to a trunk line that feeds into a sump tank, each drain tube comprising a one-way valve,
a respective solenoid valve coupled to each trunk line to thereby actuate the one-way valve of each drain tube; and
an aquaculture system, comprising:
a fish tank,
a digestor assembly coupled to the fish tank, the digestor assembly comprising:
a skimmer tank situated above a digestor tank, the skimmer tank comprising a solids valve to release undissolved solids into the digestor tank,
the digestor tank comprising an aeration stone coupled to an air pump, and a recycling pump configured to recycle the contents of the digestor tank,
a conduit to feed water from the skimmer tank to a media bed, and a fill tank configured to receive water from the media bed, the fill tank comprising one or more rack pumps configured to pump water to the one or more grow racks, and a fish tank pump configured to feed water back to the fish tank.

13. The aquaponics system of claim 12, wherein the media bed comprises a bell siphon configured to siphon water from the media bed and into the fill tank.

14. The aquaponics system of claim 13, wherein the bell siphon is surrounded by lava rock.

15. The aquaponics system of claim 12, wherein each row comprises an overflow outlet coupled to each overflow tube to allow water to flow from a higher row of the plurality of rows to each lower row of the plurality of rows.

16. The aquaponics system of claim 15, wherein a height of the overflow outlet determines an amount of water in each row.

17. The aquaponics system of claim 12, wherein the respective solenoid valves are programmed to actuate at user-defined intervals.

18. A method of using an aquaponics system, comprising:
coupling an aquaculture system to a hydroponic system, wherein the hydroponic system is configured to automatically cycle water therethrough using one or more solenoid valves, including the steps of:
feeding water and fish waste from a fish tank to a digestor assembly, the digestor assembly comprising a skimmer tank and a digestor tank;
using the skimmer tank to separate undissolved solids from the water;
releasing the undissolved solids into the digestor tank, wherein the digestor tank is configured to churn the undissolved solids and create a soil amendment;
feeding the water from the skimmer tank to a media bed for further filtering, wherein the water is siphoned into a fill tank; and
providing the water from the fill tank to the hydroponic system and back to the fish tank.

19. The method of claim 18, wherein the water from the fill tank enters a top row of a plurality of rows of a grow rack of the hydroponic system, wherein the water flows to each subsequent row via an overflow outlet and overflow tube.

20. The method of claim 18, wherein the one or more solenoid valves are coupled to one or more drain tubes, the one or more solenoid valves being programmed to actuate at timed intervals, wherein the water is drained from each row via the one or more drain tubes.
